(19) United States
(12) Patent Application Publication
(10) Pub. No.: US 2010/0234523 A1
(43) Pub. Date: Sep. 16, 2010

(54) Active energy beam-curable ink

(75) Inventors: Shunsuke Uozumi, Ibaraki-ken (JP); Hajime Tsunoda, Ibaraki-ken (JP); Kazuhiro Higashi, Ibaraki-ken (JP); Masami Shinozaki, Ibaraki-ken (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/656,873

(22) Filed: Feb. 18, 2010

(30) Foreign Application Priority Data
Mar. 12, 2009 (JP) P2009-059229

(51) Int. Cl. C08L 33/08

(52) U.S. Cl. 524/559

(57) ABSTRACT

An active energy beam-curable ink, comprising a polytetramethylene glycol diacrylate, a bifunctional to tetrafunctional urethane acrylate and a colorant, wherein an amount of the polytetramethylene glycol diacrylate relative to a total mass of the ink is not less than 35% by mass, and an amount of the bifunctional to tetrafunctional urethane acrylate relative to a total mass of the ink is within a range from 5 to 35% by mass.

### CROSS REFERENCE TO RELATED APPLICATIONS

This Application is based upon and claims the benefit of priority from prior Japanese Patent Application No. 2009-059229 filed on Mar. 12, 2009; the entire contents of which are incorporated by reference herein.

### BACKGROUND OF THE INVENTION

1. Field of the Invention

The present invention relates to active energy beam-curable ink.

2. Description of the Related Art

Active energy beam-curable inks, which use a compound that polymerizes upon irradiation with an active energy beam such as an ultraviolet light beam as a vehicle, exhibit excellent rapid drying properties, and do not require a heated drying step. Furthermore, because these inks are solventless, they also offer the advantages of causing no environmental contamination and having a high degree of safety.

On the other hand, an inkjet recording method is a printing method in which a liquid ink with a high degree of fluidity is sprayed from very fine nozzles and adhered to a recording medium such as a sheet of paper, and because it enables the printing of high-resolution, high-quality images at high speed and with minimal noise using a comparatively inexpensive printing apparatus, it is a recording method that is rapidly becoming widespread.

The inks used in this type of inkjet recording method require a variety of different properties, including low viscosity, sufficient surface tension to enable the generation of the fine droplets sprayed from the nozzles of the inkjet head, low volatility, and favorable long-term stability.

Particularly in those cases where an active energy beam-curable ink is used, in addition to the properties listed above, the ink also requires to be able to form a coating film or film with a powerful coating film strength and favorable flexibility.

If the flexibility of the cured film is inadequate, then when the film surface is subjected to a deformation such as bending or cutting, cracks may form in the film, or the film may peel. Moreover, because the flexibility of the film decreases at lower temperatures, cracking and peeling tend to be more prevalent under low-temperature conditions. For example, in the case of drink containers that are to be refrigerated or packaging containers for frozen foods, the printed item may be subjected to bending within a low-temperature environment, and therefore flexibility is an important issue.

Patent Document 1 (Japanese Patent Laid-Open No. 2003-192943) proposes an ink for inkjet recording that can be cured by irradiation, wherein by using a specific combination of polymerizable compounds, an ink can be provided that suffers no bleeding, has a high degree of curing sensitivity, exhibits good adhesion of the image to the recording medium, and has a high level of safety. Patent Document 1 discloses an ink that uses a combination of a polytetramethylene glycol diacrylate and a hexafunctional urethane acrylate as the polymerizable compounds.

### SUMMARY OF THE INVENTION

However, Patent Document 1 discloses no investigation of the amounts added of the polytetramethylene glycol diacrylate and the urethane acrylate or the degree of functionality of the urethane acrylate from the perspective of the flexibility of the resulting coating film. Consequently, it cannot be claimed that this document discloses an appropriate combination of polymerizable compounds for improving the flexibility of the coating film under all temperature conditions.

Accordingly, an object of the present invention is to provide an active energy beam-curable ink that improves the flexibility of the ink film.

A first aspect of the present invention provides an active energy beam-curable ink comprising a polytetramethylene glycol diacrylate, a bifunctional to tetrafunctional urethane acrylate and a colorant, wherein the amount of the polytetramethylene glycol diacrylate relative to the total mass of the ink is not less than 35% by mass, and the amount of the bifunctional to tetrafunctional urethane acrylate relative to the total mass of the ink is within a range from 5 to 35% by mass.

### DETAILED DESCRIPTION OF THE EMBODIMENTS

A description of embodiments according to the present invention is presented below, but the examples within these embodiments in no way limit the scope of the present invention.

The active energy beam-curable ink of the present invention enables the flexibility of the ink film to be improved.

The active energy beam-curable ink according to the present invention (hereafter also referred to as simply “the ink”) comprises a polytetramethylene glycol diacrylate, a bifunctional to tetrafunctional urethane acrylate and a colorant, wherein the amount of the polytetramethylene glycol diacrylate relative to the total mass of the ink is not less than 35% by mass, and the amount of the bifunctional to tetrafunctional urethane acrylate relative to the total mass of the ink is within a range from 5 to 35% by mass. By using an ink of this type, the flexibility of the ink film can be improved.

The ink of the present invention can be printed onto all manner of recording media, including paper media such as plain paper and coated paper, resin films such as OHT sheets, fabrics, leather and metals and the like, and in each case, the flexibility of the ink film can be improved. Furthermore satisfactory ink film flexibility can be achieved not only at room temperature, but also under low-temperature conditions.

The ink of the present invention comprises a polytetramethylene glycol diacrylate and a bifunctional to tetrafunctional urethane acrylate, and these compounds function as polymerizable compounds. The polytetramethylene glycol diacrylate can be used as a reactive diluent component, and the bifunctional to tetrafunctional urethane acrylate can be used as an oligomer component.

The amount of the polytetramethylene glycol diacrylate represents not less than 35% by mass of the total mass of the ink.

The polytetramethylene glycol diacrylate is a compound represented by the general formula shown below:

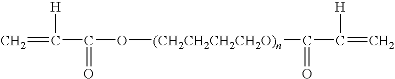

wherein the average value of n is preferably within a range from 2 to 6, more preferably from 2 to 4, and still more preferably from 2.5 to 3.5. If the average value of n is less than 2, then the skin irritancy and flexibility properties tend to deteriorate, whereas if the average value of n exceeds 6, then the dilution properties and curability tend to deteriorate.

The weight average molecular weight of the polytetramethylene glycol diacrylate may be any value provided the average value of n satisfies the above range, but is preferably within a range from 270 to 420, and more preferably from 300 to 400.

An example of a compound that may be used favorably as the polytetramethylene glycol diacrylate is the product ADT250, manufactured by NOF Corporation.

The amount of the polytetramethylene glycol diacrylate relative to the total mass of the ink is not less than 35% by mass, and is preferably 45% by mass or greater. Provided this amount is at least 35% by mass, satisfactory flexibility of the ink film can be obtained, and particularly the flexibility under low-temperature conditions is superior. Moreover, if the amount is 45% by mass or greater, then even more favorable ink film flexibility can be achieved, and in particular, the resistance to folding of an ink film printed under low-temperature conditions onto a recording medium that is comparatively impermeable to ink such as a coated paper can be significantly improved.

Although there are no particular restrictions on the upper limit for the amount of the polytetramethylene glycol diacrylate, because predetermined amounts of other components must be included, the amount of the polytetramethylene glycol diacrylate relative to the total mass of the ink is preferably not more than 80% by mass.

The ink of the present invention also comprises a bifunctional to tetrafunctional urethane acrylate in an amount within a range from 5 to 35% by mass relative to the total mass of the ink.

By ensuring that the urethane acrylate is bifunctional or higher, an ink film having excellent curability is obtained. Further, provided the urethane acrylate is tetrafunctional or lower, the cross-linking density can be reduced and the flexibility of the ink film can be improved.

The weight average molecular weight of the bifunctional to tetrafunctional urethane acrylate is preferably at least 1,000, and more preferably 1,500 or greater. Ensuring that the weight average molecular weight is at least 1,000 not only enables satisfactory ink film flexibility to be obtained, but also improves the cutting resistance of the ink film under low-temperature conditions. Even if the weight average molecular weight is less than 1,000, and for example, is within a range from approximately 400 to 600, satisfactory flexibility can still be obtained for the ink film.

Specific examples of products that can be used favorably as the above type of bifunctional to tetrafunctional urethane acrylate include bifunctional urethane acrylates such as the products M-1200 manufactured by Toagosei Co., Ltd., EB8402 and EB270 manufactured by Daicel-Cytec Co., Ltd. and UV-3000B manufactured by Nippon Synthetic Industry Co., Ltd., and tetrafunctional urethane acrylates such as the products EB8405 and EB8210 manufactured by Daicel-Cytec Co., Ltd.

The amount of the bifunctional to tetrafunctional urethane acrylate relative to the total mass of the ink is typically within a range from 5 to 35% by mass, preferably from 10 to 26% by mass, and still more preferably from 10 to 20% by mass. By ensuring that this amount is at least 5% by mass, the flexibility of the ink film can be improved, whereas ensuring that the amount is not more than 35% by mass suppresses an increase in the ink viscosity, and enables an ink viscosity to be obtained that is suitable for discharge from an inkjet head.

The ink of the present invention may also comprise other polymerizable compounds besides the above polytetramethylene glycol diacrylate and bifunctional to tetrafunctional urethane acrylate, provided these other compounds do not impair the effects of the present invention.

Examples of these other polymerizable compounds include oligomers and monomers of (meth)acrylic acid-modified derivatives of all manner of compounds such as urethane-based, epoxy-based, polyether-based and polyol-based compounds, as well as oligomers and monomers of unsaturated polyester compounds and aromatic vinyl compounds. In this description, a polymerizable compound that is a monomer may be referred to as a “reactive diluent”, whereas a polymerizable compound that is an oligomer may be referred to as simply an “oligomer”.

Examples of the above oligomers include epoxy acrylates, epoxidized oil acrylates, polyester acrylates, polyether acrylates, vinyl acrylates, and monofunctional or pentafunctional or higher urethane acrylates. Examples of the above monomers include monofunctional acrylates and polyfunctional acrylates. Specific examples of the monofunctional acrylates include dicyclopentenylethyl acrylate, isobornyl acrylate, and phenol ethylene oxide-modified acrylates. Specific examples of the polyfunctional acrylates include tripropylene glycol diacrylate, 1,9-nonanediol diacrylate, 1,6-hexanediol diacrylate, bisphenol A diglycidyl ether diacrylate, tetraethylene glycol diacrylate, trimethylolpropane triacrylate, pentaerythritol triacrylate, pentaerythritol tetraacrylate, dipentaerythritol hexaacrylate, and neopentyl glycol hydroxypivalate diacrylate. Any one of these monomers or oligomers may be used individually, or two or more may be used in combination.

There are no particular restrictions on the colorant included in the ink of the present invention, and examples of the colorant include pigments, dyes, and mixtures thereof.

Examples of pigments that can be used favorably include organic pigments such as azo-based pigments, phthalocyanine-based pigments, dye-based pigments, condensed polycyclic pigments, nitro-based pigments, and nitroso-based pigments (such as carmine 6B, lake red, disazo yellow, phthalocyanine blue, aniline black, alkali blue and quinacridone); inorganic pigments, including metals such as cobalt, chromium, copper, zinc, lead, titanium, vanadium, manganese and nickel, metal oxides and sulfides, and yellow ocher, ultramarine and iron blue pigments; as well as carbon black, titanium oxide, and zinc oxide.

Examples of dyes that can be used include oil-soluble dyes such as azo-based dyes, anthraquinone-based dyes and azine-based dyes. Either a pigment or a dye may be used as the colorant, but using a pigment yields an ink that also exhibits excellent light resistance.

The amount of the colorant relative to the total mass of the ink is preferably within a range from 0.1 to 50% by mass, and more preferably from 1 to 30% by mass.

A pigment dispersant may be used to disperse the pigment. Examples of materials that may be used as the pigment dispersant include hydroxyl group-containing carboxylate esters, salts of long-chain polyaminoamides and high molecular weight acid esters, salts of high molecular weight polycarboxylic acids, salts of long-chain polyaminoamides and polar acid esters, high molecular weight unsaturated acid esters, high molecular weight copolymers, modified polyurethanes, modified polyacrylates, polyetherester-type anionic activators, naphthalenesulfonic acid formalin condensate salts, polyoxyethylene alkyl phosphate esters, polyoxyethylene nonylphenyl ethers, polyester polyamines and stearylamine acetate.

Specific examples of the dispersant include products manufactured by BYK Chemie such as Anti-Terra-U (a polyaminoamide phosphate), Anti-Terra-203/204 (salts of high molecular weight polycarboxylic acids), Disperbyk-101 (a phosphate salt of long chain polyamine amides and a polar acid ester), 107 (a hydroxyl group-containing carboxylate ester), 110 (a copolymer containing acid groups), 130 (a polyamide), 161, 162, 163, 164, 165, 166 and 170 (high molecular weight copolymers), 400, Bykumen (an ester of a high molecular weight unsaturated acid), BYK-P104 and P105 (high molecular weight unsaturated polycarboxylic acids), P104S (a mixture of a lower molecular weight unsaturated polycarboxylic acid polymer and a polysiloxane copolymer) and 240S (a high molecular weight unsaturated polycarboxylic acid), and Lactimon (a mixture of a partially amidated lower molecular weight unsaturated polycarboxylic acid polymer, an alkylammonium salt of a lower molecular weight unsaturated polycarboxylic acid polymer, and a polysiloxane copolymer).

Furthermore, products manufactured by Efka Chemicals include Efka 44, 46, 47, 48, 49, 54, 63, 64, 65, 66, 71, 701, 764 and 766, Efka Polymer 100 (a modified polyacrylate), 150 (an aliphatic modified polymer), 400, 401, 402, 403, 450, 451, 452 and 453 (modified polyacrylates), and 745 (a copper phthalocyanine compound); products manufactured by Kyoeisha Chemical Co., Ltd. include Florene TG-710 (a urethane oligomer), Florene DOPA-15B (an acrylic oligomer), Florene SH-290, SP-1000, and Polyflow No. 50E and No. 300 (acrylic copolymers); and products manufactured by Kusumoto Chemicals Ltd. include Disparlon KS-860, 873 SN and 874 (high molecular weight dispersants), #2150 (an aliphatic polyvalent carboxylic acid), #7004 (a polyetherester), and DA-703-50 (a polyester acid amide amine salt).

Moreover, products manufactured by Kao Corporation include Demol RN and N (sodium salts of naphthalenesulfonic acid-formalin condensates), MS.C and SN-B (sodium salts of aromatic sulfonic acid-formalin condensates), and EP, Homogenol L-18 (a polycarboxylic acid type polymer), Emulgen 920, 930, 931, 935, 950 and 985 (polyoxyethylene nonylphenyl ethers), and Acetamine 24 (a coconut amine acetate) and 86 (stearylamine acetate); and products manufactured by The Lubrizol Corporation include Solsperse 13940 (a polyesteramine compound), 17000 and 18000 (fatty acid amine compounds), and 22000, 24000, 28000 and 32000.

The amount added of the pigment dispersant, reported as a mass ratio relative to a value of 1 for the pigment, is preferably within a range from 0.05 to 1.

Furthermore, in order to accelerate the action by which the pigment dispersant adsorbs to the pigment, a synergist (pigment derivative) may also be added. An example of a product that may be used as the synergist is Solsperse 5000 (a phthalocyanine ammonium salt compound), manufactured by The Lubrizol Corporation. The synergist is typically added in an amount, reported as a mass ratio relative to a value of 1 for the pigment, within a range from 0.0005 to 0.1.

A polymerization initiator may be added to the ink. There are no particular restrictions on the polymerization initiator, and typical polymerization initiators may be used. Examples include photopolymerization initiators such as Irgacure 819, Irgacure 184, Darocure 1173, Irgacure 907, Irgacure 369 and Irgacure 379 (all manufactured by Ciba Japan K.K.), Kayacure DETX and Kayacure ITX (both manufactured by Nippon Kayaku Co., Ltd.), Lucirin TPO (manufactured by BASF Corporation), benzophenone, acetophenone, 4,4′-bisdiethylaminobenzophenone, benzil, benzoin and benzoin ethyl ether. Any of these photopolymerization initiators may be used individually, or two or more may be used in combination. The photopolymerization initiator is typically added in an amount within a range from 1 to 20% by mass relative to the total mass of the ink.

If required, a sensitizer may also be added to the ink. Examples of the sensitizer include aliphatic amines such as n-butylamine, triethylamine and ethyl p-dimethylaminobenzoate, aromatic amines, and 2,4-diethylthioxanthone. Any of these sensitizers may be used individually, or two or more may be used in combination. Commercially available sensitizers such as DETX-S and EPA manufactured by Nippon Kayaku Co., Ltd. may also be used. The sensitizer is typically added in an amount within a range from 0.1 to 10% by mass relative to the total mass of the ink.

A polymerization inhibitor such as hydroquinone monomethyl ether or aluminum N-nitrosophenylhydroxylamine may also be added to the ink for the purpose of preventing gelling of the ink during storage. Any of these types of polymerization inhibitors may be used individually, or two or more may be used in combination. An example of a commercially available polymerization inhibitor is the product Q-1301 manufactured by Wako Pure Chemical Industries, Ltd. The polymerization inhibitor is typically added in an amount within a range from 0.01 to 0.5% by mass relative to the total mass of the ink.

Besides the components described above, the ink of the present invention may also include suitable amounts of additive components including antibacterial agents, preservatives, moldproofing agents, pH modifiers, dissolution assistants, antioxidants, nozzle blockage prevention agents, conductivity modifiers, viscosity modifiers, surface tension modifiers and oxygen absorbers.

Specific examples of the preservatives and moldproofing agents include sodium benzoate, sodium pentachlorophenol, sodium 2-pyridinethiol 1-oxide, sodium sorbate, sodium dehydroacetate, and 1,2-dibenzisothiazolin-3-one (Proxel CRL, Proxel BDN, Proxel GXL, Proxel XL-2 and Proxel TN, manufactured by Arch Chemicals Japan, Inc.).

Examples of the pH modifiers, dissolution assistants and antioxidants include amines and modified products thereof such as diethanolamine, triethanolamine, propanolamine and morpholine, inorganic salts such as potassium hydroxide, sodium hydroxide and lithium hydroxide, ammonium hydroxide and quaternary ammonium hydroxides (such as tetramethylammonium hydroxide), carbonates such as potassium carbonate, sodium carbonate and lithium carbonate, other phosphates, as well as N-methyl-2-pyrrolidone, urea compounds such as urea, thiourea and tetramethyl urea, allophanates such as allophanate and methylallophanate, biurets such as biuret, dimethylbiuret and tetramethylbiuret, and L-ascorbic acid and salts thereof.

There are no particular restrictions on the method used for preparing the ink of the present invention, and for example, the ink can be produced by mixing the above components using a dispersion device such as a beads mill, disper mixer, homomixer, colloid mill, ball mill, attritor or sand mill. Further, the ink may also be prepared by first preparing a pigment dispersion containing the pigment, a portion of the reactive diluent, and suitable amounts of the pigment dispersant and the polymerization inhibitor, and then adding and blending the remaining reactive diluent, the oligomer, and suitable amounts of the polymerization initiator and sensitizer into this pigment dispersion.

The viscosity of the ink of the present invention may be altered as appropriate, but from the viewpoint of achieving favorable discharge properties at the inkjet head, is preferably within a range from 5 to 100 mPa·s. This viscosity is measured at 25° C. by raising the shear stress from 0 Pa at a rate of 0.1 Pa/s, and refers to the ink viscosity at 10 Pa.

The ink of the present invention is suited to printing using an inkjet printer. The inkjet printer used for conducting the printing may employ any of various printing systems, including a thermal system, piezo system or electrostatic system, and discharges the ink of the present invention from the inkjet nozzles based on a digital signal, and adheres the discharged ink droplets to the item being printed such as a sheet of paper. Subsequently, an active energy beam is irradiated onto the printed surface to cure the ink film. A printed item obtained in this manner exhibits excellent flexibility of the ink film, meaning cracking or peeling of the film surface can be prevented.

There are no particular restrictions on the active energy beam used for conducting the curing, and examples include electromagnetic waves such as ultraviolet rays, X-rays or γ-rays. Of the various possibilities, for reasons including the wavelength absorption properties of the polymerization initiator, the resins used, and the general availability of the irradiation apparatus, an ultraviolet-curable ink is preferred. In such cases, examples of preferred light sources include a high-pressure mercury lamp, metal halide lamp or xenon lamp. Further, in those cases where the active energy beam is irradiated using an inkjet printer, irradiation can be performed immediately following printing by using an optical fiber-based light source such as an Optical Modulex manufactured by Ushio Inc., and installing this optical fiber next to the inkjet head so that the light source can move in tandem with the movement of the head.

### EXAMPLES

A more detailed description of the present invention is provided below based on a series of examples, although the present invention is in no way limited by these examples.

### <Ink Preparation>

The components shown in Table 1 were mixed together and dispersed using a beads mill, thus forming a series of pigment dispersions. Subsequently, these pigment dispersions were combined with the components shown in Table 2 and mixed thoroughly using a high-speed mixer, thus yielding inks of the examples and comparative examples. The final formulation of each of the obtained inks is detailed in Table 3. Details relating to each of the components listed in the tables are shown in Table 4.

### <Evaluations>

Each of the inks from the examples and comparative examples was subjected to the evaluations described below. The results of those evaluations are also included in Table 3.

### <Method of Preparing Printed Items>

The ink of each example and comparative example was loaded into an inkjet recording apparatus HC5000 (manufactured by Riso Kagaku Corporation), and following printing onto plain paper (Riso light paper, manufactured by Riso Kagaku Corporation) or coated paper (Aurora coated paper, manufactured by Nippon Paper Group, Inc.), ultraviolet light was irradiated onto the printed surface using a metal halide lamp (manufactured by Fusion UV Systems Japan K.K., peak wavelength: 365 nm), thus forming a printed item.

### <Evaluation of Resistance to Folding>

The resistance to folding was evaluated at a temperature of −10° C. using the plain paper and coated paper printed items that had been printed with the inks of each of the examples and comparative examples. Each printed item was folded 180° C., the surface state of the folded ink film was inspected visually, and the resistance to folding was evaluated using the criteria below.

A: no cracks occurred within the film surface

B: minor cracks appeared in the film surface (but were of a level that may not present an obstacle to use, depending on the intended application)

C: cracks occurred in the film surface

### <Evaluation of Resistance to Cutting>

The resistance to cutting was evaluated at a temperature of −10° C. using the coated paper printed items that had been printed with the inks of each of the examples and comparative examples. The printed surface of the printed item was cut using a PK-013 device manufactured by PLUS Corporation, the cut surface was inspected visually, and the resistance to cutting was evaluated using the criteria below.

A: no cracks occurred within the cut surface

B: minor cracks appeared emanating from some portions of the cut surface (but were of a level that may not present an obstacle to use, depending on the intended application)

C: significant cracks occurred emanating from the cut surface

### <Evaluation of Ink Viscosity>

The viscosity represents the viscosity at 10 Pa when the shear stress was raised from 0 Pa at a rate of 0.1 Pa/s at a temperature of 25° C., and was measured using a controlled stress rheometer RS75 manufactured by Haake GmbH (cone angle: 1°, diameter: 60 mm).

TABLE 1
Pigment dispersions

| | Product | | | | | | | Comparative |
|---|---|---|---|---|---|---|---|---|
| Parts by mass | number | Example 1 | Example 2 | Example 3 | Example 4 | Example 5 | Example 6 | example 1 |
| Pigment | MA11 | 5.00 | 5.00 | 5.00 | 5.00 | 5.00 | 5.00 | 5.00 |
| Pigment | Sol.32000 | 2.00 | 2.00 | 2.00 | 2.00 | 2.00 | 2.00 | 2.00 |
| dispersant | | | | | | | | |
| Synergist | Sol.5000 | 0.20 | 0.20 | 0.20 | 0.20 | 0.20 | 0.20 | 0.20 |
| Reactive | ADT250 | 17.75 | 10.00 | — | — | — | — | — |
| diluent | MANDA | — | 7.75 | — | — | — | — | — |
| | SR-335 | — | — | — | — | — | — | 17.75 |
| | 1,9-NDA | — | — | 17.75 | 17.75 | 17.75 | 17.75 | — |
| Polymerization | Q-1301 | 0.05 | 0.05 | 0.05 | 0.05 | 0.05 | 0.05 | 0.05 |
| inhibitor | | | | | | | | |

| | | | | | | | |
|---|---|---|---|---|---|---|---|
| Total | 25.00 | 25.00 | 25.00 | 25.00 | 25.00 | 25.00 | 25.00 |

| | Product | Comparative | Comparative | Comparative | Comparative | Comparative |
|---|---|---|---|---|---|---|
| Parts by mass | number | example 2 | example 3 | example 4 | example 5 | example 6 |
| Pigment | MA11 | 5.00 | 5.00 | 5.00 | 5.00 | 5.00 |
| Pigment | Sol.32000 | 2.00 | 2.00 | 2.00 | 2.00 | 2.00 |
| dispersant | | | | | | |
| Synergist | Sol.5000 | 0.20 | 0.20 | 0.20 | 0.20 | 0.20 |
| Reactive | ADT250 | — | — | — | 17.75 | — |
| diluent | MANDA | 17.75 | — | — | — | — |
| | SR-335 | — | 17.75 | — | — | |
| | 1,9-NDA | — | — | 17.75 | — | 17.75 |
| Polymerization | Q-1301 | 0.05 | 0.05 | 0.05 | 0.05 | 0.05 |
| inhibitor | | | | | | |

| | | | | | |
|---|---|---|---|---|---|
| Total | 25.00 | 25.00 | 25.00 | 25.00 | 25.00 |

TABLE 2
Ink formulations

| | Product | | | | | | | Comparative |
|---|---|---|---|---|---|---|---|---|
| Parts by mass | number | Example 1 | Example 2 | Example 3 | Example 4 | Example 5 | Example 6 | example 1 |
| Pigment | — | 25.00 | 25.00 | 25.00 | 25.00 | 25.00 | 25.00 | 25.00 |
| dispersion | | | | | | | | |
| Polymerization | Irg.379 | 4.00 | 4.00 | 4.00 | 4.00 | 4.00 | 4.00 | 4.00 |
| initiator | | | | | | | | |
| Sensitizer | DETX-S | 4.00 | 4.00 | 4.00 | 4.00 | 4.00 | 4.00 | 4.00 |
| | EPA | 4.00 | 4.00 | 4.00 | 4.00 | 4.00 | 4.00 | 4.00 |
| Reactive | ADT250 | 53.00 | 35.00 | 45.00 | 40.00 | 35.00 | 45.00 | — |
| diluent | MANDA | — | 2.00 | 10.50 | 13.00 | 13.00 | 8.00 | — |
| | SR268 | — | — | — | — | — | — | 50.00 |
| | IRR-214K | — | — | — | — | — | — | — |
| | SR-335 | — | — | — | — | — | — | 13.00 |
| Oligomer | M-1200 | 10.00 | — | — | — | — | — | — |
| | EB8402 | — | 26.00 | — | — | — | — | — |
| | EB8405 | — | — | 7.50 | — | — | — | — |
| | UV-3000B | — | — | — | 10.00 | — | — | — |
| | EB270 | — | — | — | — | 15.00 | — | — |
| | EB8210 | — | — | — | — | — | 10.00 | — |
| | EB220 | — | — | — | — | — | — | — |

| | | | | | | | |
|---|---|---|---|---|---|---|---|
| Total | 100.00 | 100.00 | 100.00 | 100.00 | 100.00 | 100.00 | 100.00 |

| | Product | Comparative | Comparative | Comparative | Comparative | Comparative |
|---|---|---|---|---|---|---|
| Parts by mass | number | example 2 | example 3 | example 4 | example 5 | example 6 |
| Pigment | — | 25.00 | 25.00 | 25.00 | 25.00 | 25.00 |
| dispersion | | | | | | |
| Polymerization | Irg.379 | 4.00 | 4.00 | 4.00 | 4.00 | 4.00 |
| initiator | | | | | | |
| Sensitizer | DETX-S | 4.00 | 4.00 | 4.00 | 4.00 | 4.00 |
| | EPA | 4.00 | 4.00 | 4.00 | 4.00 | 4.00 |
| Reactive | ADT250 | — | — | 30.00 | 63.00 | 40.00 |
| diluent | MANDA | 53.00 | — | 23.00 | — | 13.00 |
| | SR268 | — | — | — | — | — |
| | IRR-214K | — | 40.00 | — | — | — |
| | SR-335 | — | 13.00 | — | — | — |
| Oligomer | M-1200 | 10.00 | 10.00 | — | — | — |
| | EB8402 | — | — | — | — | — |
| | EB8405 | — | — | — | — | — |
| | UV-3000B | — | — | 10.00 | — | — |
| | EB270 | — | — | — | — | — |
| | EB8210 | — | — | — | — | — |
| | EB220 | — | — | — | — | 10.00 |

| | | | | | |
|---|---|---|---|---|---|
| Total | 100.00 | 100.00 | 100.00 | 100.00 | 100.00 |

TABLE 3
Final ink formulations

| | Abbreviated | | | | | | | Comparative |
|---|---|---|---|---|---|---|---|---|
| Mass % | name | Example 1 | Example 2 | Example 3 | Example 4 | Example 5 | Example 6 | example 1 |
| Pigment | MA11 | 5.00 | 5.00 | 5.00 | 5.00 | 5.00 | 5.00 | 5.00 |
| Pigment | Sol.32000 | 2.00 | 2.00 | 2.00 | 2.00 | 2.00 | 2.00 | 2.00 |
| dispersant | | | | | | | | |
| Synergist | Sol.5000 | 0.20 | 0.20 | 0.20 | 0.20 | 0.20 | 0.20 | 0.20 |
| Polymerization | Q-1301 | 0.05 | 0.05 | 0.05 | 0.05 | 0.05 | 0.05 | 0.05 |
| inhibitor | | | | | | | | |
| Polymerization | Irg.379 | 4.00 | 4.00 | 4.00 | 4.00 | 4.00 | 4.00 | 4.00 |
| initiator | | | | | | | | |
| Sensitizer | DETX-S | 4.00 | 4.00 | 4.00 | 4.00 | 4.00 | 4.00 | 4.00 |
| | EPA | 4.00 | 4.00 | 4.00 | 4.00 | 4.00 | 4.00 | 4.00 |
| Reactive | ADT250 | 70.75 | 45.00 | 45.00 | 40.00 | 35.00 | 45.00 | — |
| diluent | MANDA | — | 9.75 | 10.50 | 13.00 | 13.00 | 8.00 | — |
| | SR268 | — | — | — | — | — | — | 50.00 |
| | IRR-214K | — | — | — | — | — | — | — |
| | SR-335 | — | — | — | — | — | — | 30.75 |
| | 1,9-NDA | — | — | 17.75 | 17.75 | 17.75 | 17.75 | — |
| Oligomer | M-1200 | 10.00 | — | — | — | — | — | — |
| | EB8402 | — | 26.00 | — | — | — | — | — |
| | EB8405 | — | — | 7.50 | — | — | — | — |
| | UV-3000B | — | — | — | 10.00 | — | — | — |
| | EB270 | — | — | — | — | 15.00 | — | — |
| | EB8210 | — | — | — | — | — | 10.00 | — |
| | EB220 | — | — | — | — | — | — | — |

| Total | | 100.00 | 100.00 | 100.00 | 100.00 | 100.00 | 100.00 | 100.00 |
|---|---|---|---|---|---|---|---|---|
| Evaluations | Resistance to folding | A | A | A | A | A | A | C |
| | (−10° C.)/plain paper | | | | | | | |
| | Resistance to folding | A | A | A | B | B | A | C |
| | (−10° C.)/coated paper | | | | | | | |
| | Resistance to cutting | A | A | A | A | A | B | C |
| | (−10° C.)/coated paper | | | | | | | |
| | Viscosity(mPa · s/ | 79 | 85 | 66 | 69 | 77 | 50 | 44 |
| | 25° C.) | | | | | | | |

| | Abbreviated | Comparative | Comparative | Comparative | Comparative | Comparative |
|---|---|---|---|---|---|---|
| Mass % | name | example 2 | example 3 | example 4 | example 5 | example 6 |
| Pigment | MA11 | 5.00 | 5.00 | 5.00 | 5.00 | 5.00 |
| Pigment | Sol.32000 | 2.00 | 2.00 | 2.00 | 2.00 | 2.00 |
| dispersant | | | | | | |
| Synergist | Sol.5000 | 0.20 | 0.20 | 0.20 | 0.20 | 0.20 |
| Polymerization | Q-1301 | 0.05 | 0.05 | 0.05 | 0.05 | 0.05 |
| inhibitor | | | | | | |
| Polymerization | Irg.379 | 4.00 | 4.00 | 4.00 | 4.00 | 4.00 |
| initiator | | | | | | |
| Sensitizer | DETX-S | 4.00 | 4.00 | 4.00 | 4.00 | 4.00 |
| | EPA | 4.00 | 4.00 | 4.00 | 4.00 | 4.00 |
| Reactive | ADT250 | — | — | 30.00 | 80.75 | 40.00 |
| diluent | MANDA | 70.75 | — | 23.00 | — | 13.00 |
| | SR268 | — | — | — | — | — |
| | IRR-214K | — | 40.00 | — | — | — |
| | SR-335 | — | 30.75 | — | — | — |
| | 1,9-NDA | — | — | 17.75 | — | 17.75 |
| Oligomer | M-1200 | 10.00 | 10.00 | — | — | — |
| | EB8402 | — | — | — | — | — |
| | EB8405 | — | — | — | — | — |
| | UV-3000B | — | — | 10.00 | — | — |
| | EB270 | — | — | — | — | — |
| | EB8210 | — | — | — | — | — |
| | EB220 | — | — | — | — | 10.00 |

| Total | | 100.00 | 100.00 | 100.00 | 100.00 | 100.00 |
|---|---|---|---|---|---|---|
| Evaluations | Resistance to folding | C | C | C | B | C |
| | (−10° C.)/plain paper | | | | | |
| | Resistance to folding | C | C | C | C | C |
| | (−10° C.)/coated paper | | | | | |
| | Resistance to cutting | B | B | B | C | C |
| | (−10° C.)/coated paper | | | | | |
| | Viscosity(mPa · s/ | 69 | 93 | 62 | 25 | 60 |
| | 25° C.) | | | | | |

TABLE 4
Details of components

| | Product | | | Weight average |
|---|---|---|---|---|
| | number | Component | Manufacturer | molecular weight |
| Pigment | MA11 | Carbon black | Mitsubishi Chemical Corporation | |
| Pigment dispersant | Sol.32000 | Polymer dispersant | The Lubrizol Corporation | |
| Synergist | Sol.5000 | Phthalocyanine derivative | The Lubrizol Corporation | |
| Polymerization | Q-1301 | Aluminum N-nitrosophenylhydroxylamine | Wako Pure Chemical Industries, Ltd. | |
| inhibitor | | | | |
| Polymerization | Irg.379 | 2-dimethylamino-2-(4-methylbenzyl)-1- | Ciba Japan K.K. | |
| initiator | | (4-morpholin-4-ylphenyl)-butan-1-one | | |
| Sensitizer | DETX-S | 2,4-diethylthioxanthone | Nippon Kayaku Co., Ltd. | |
| | EPA | Ethyl p-dimethylaminobenzoate | Nippon Kayaku Co., Ltd. | |
| Reactive | ADT250 | Polytetramethylene glycol diacrylate | NOF Corporation | 342 |
| diluent | MANDA | neopentyl glycol hydroxypivalate diacrylate | Nippon Kayaku Co., Ltd. | 312 |
| | SR268 | Tetraethylene glycol diacrylate | Sartomer Company, Inc. | 302 |
| | IRR-214K | Dimethyloldicyclopentane diacrylate | Daicel-Cytec Co., Ltd. | 304 |
| | SR-335 | Lauryl acrylate | Sartomer Company, Inc. | 240 |
| | 1,9-NDA | Nonanediol diacrylate | Kyoeisha Chemical Co., Ltd. | 268 |
| Oligomer | M-1200 | Bifunctional urethane acrylate | Toagosei Co., Ltd. | 1000-1500 |
| | EB8402 | Bifunctional urethane acrylate | Daicel-Cytec Co., Ltd. | 1000 |
| | EB8405 | Tetrafunctional urethane acrylate | Daicel-Cytec Co., Ltd. | 2700 |
| | UV-3000B | Bifunctional urethane acrylate | Nippon Synthetic Chemical | 18000 |
| | | | Industry Co., Ltd. | |
| | EB270 | Bifunctional urethane acrylate | Daicel-Cytec Co., Ltd. | 1700 |
| | EB8210 | Tetrafunctional urethane acrylate | Daicel-Cytec Co., Ltd. | 600 |
| | EB220 | Hexafunctional urethane acrylate | Daicel-Cytec Co., Ltd. | 1000 |

As is evident from Table 3, the printed items of each of the examples exhibited favorable folding resistance and cutting resistance, confirming that a satisfactory level of flexibility had been obtained for the ink film. Needless to say, the fact that the evaluations were favorable under low-temperature conditions indicates that the flexibility is also favorable in ambient temperature environments. Further, the inks of the examples also had low viscosities, and were suitable as inkjet inks.

In contrast, in the inks of the comparative examples, the amount of the polytetramethylene glycol diacrylate and/or the amount of the bifunctional to tetrafunctional urethane acrylate was outside the specified range, and the printed items from each of the comparative examples were unable to produce favorable results for the folding resistance and the cutting resistance.

In particular, comparative example 4 represents an example in which the amount of the polytetramethylene glycol diacrylate is low, and compared with the inks in which the amount of the polytetramethylene glycol diacrylate was at least 35% by mass, the flexibility of the printed item was unsatisfactory. Comparative example 5 contained no urethane acrylate, and comparative example 6 contained only a hexafunctional urethane acrylate, and compared with the inks that contained a bifunctional to tetrafunctional urethane acrylate, the flexibility of the printed items was unsatisfactory.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An active energy beam-curable ink, comprising a polytetramethylene glycol diacrylate, a bifunctional to tetrafunctional urethane acrylate and a colorant, wherein
an amount of the polytetramethylene glycol diacrylate relative to a total mass of the ink is not less than 35% by mass, and
an amount of the bifunctional to tetrafunctional urethane acrylate relative to a total mass of the ink is within a range from 5 to 35% by mass.

2. The active energy beam-curable ink according to claim 1, wherein a weight average molecular weight of the bifunctional to tetrafunctional urethane acrylate is not less than 1,000.

3. The active energy beam-curable ink according to claim 1, wherein a weight average molecular weight of the polytetramethylene glycol diacrylate is within a range from 270 to 420.

4. The active energy beam-curable ink according to claim 2, wherein a weight average molecular weight of the polytetramethylene glycol diacrylate is within a range from 270 to 420.
